(19) United States
(12) Patent Application Publication
(10) Pub. No.: US 2026/0061828 A1
(43) Pub. Date: Mar. 5, 2026

(54) DRIVE MECHANISM, RANGE EXTENSION DEVICE AND RANGE EXTENSION SYSTEM FOR ELECTRIC VEHICLE, AND ELECTRIC VEHICLE

(71) Applicant: ZF Friedrichshafen AG, Friedrichshafen (DE)

(72) Inventors: Qing Xu, Shanghai (CN); Shaozhi Yuan, Shanghai (CN); Lei Song, Shanghai (CN)

(73) Assignee: ZF Friedrichshafen AG, Friedrichshafen (DE)

(21) Appl. No.: 19/320,223

(22) Filed: Sep. 5, 2025

(30) Foreign Application Priority Data
Sep. 5, 2024 (CN) 202411242672.3

(51) Int. Cl. B60K 6/50; B60K 6/24; B60K 6/26; B60K 6/46

(52) U.S. Cl. CPC B60K 6/50; B60K 6/24; B60K 6/26; B60K 6/46

(57) ABSTRACT

A drive mechanism for an electric vehicle includes a first input shaft, a second input shaft, a first clutch disposed between the first input shaft and the second input shaft, a differential having a differential housing provided with an input gear, the input gear being drivingly connected to a second rotating component of the first clutch, two output shafts, one end of each of the two output shafts being drivingly connected to the differential, and a second clutch disposed on any one of the two output shafts for enabling interruption of the transmission of power from the differential. A range extension device includes the drive mechanism, a range extension system includes the range extension device, and the electric vehicle includes the range extension system.

### CROSS-REFERENCE TO RELATED APPLICATION

This application claims priority to Chinese Patent Application No. 202411242672.3, filed on Sep. 5, 2024, the entirety of which is hereby fully incorporated by reference herein.

### TECHNICAL FIELD

The present disclosure relates to the field of new energy vehicles, and in particular to a drive mechanism for an electric vehicle, a range extension device for an electric vehicle and a range extension system for an electric vehicle, and an electric vehicle.

### BACKGROUND ART

With the depletion of petroleum resources and the improvement of people's environmental awareness, there is an urgent need for environmentally friendly vehicle products that can save energy and produce low or even zero emissions. In view of this, new energy vehicles, for example, electric vehicles, are gaining increasing attention. Compared to internal combustion engines of conventional vehicles, traction motors of electric vehicles have a wider operation range, and the characteristics of constant torque at low speeds and constant power at high speeds of the motors better meet the operating requirements of the vehicles. In recent years, power drive systems for the electric vehicles and operating modes of the systems have become a research hotspot.

The prior art discloses a power coupling system for an electric vehicle, the power coupling system including an internal combustion engine 1, a generator 11 and a driving motor 12, as shown in FIG. 12. In this art, both the generator 11 and the driving motor 12 are employed, resulting in a complex structure of the vehicle and occupying a large space, and thus manufacturing costs are increased. In addition, the internal combustion engine 1 and the generator 11 are directly drivingly connected to each other in the prior art, and therefore the internal combustion engine and the generator cannot be flexibly controlled.

Thus, there is a need for improving the electric vehicles, especially range extension devices of the electric vehicles.

### SUMMARY

An objective of the present disclosure is to provide a drive mechanism, a range extension device and a range extension system for an electric vehicle, which are simple in structure and space saving, and an electric vehicle.

In order to solve the above technical problem, the present disclosure provides a drive mechanism for an electric vehicle, the drive mechanism including: a first input shaft; a second input shaft; a first clutch, disposed between the first input shaft and the second input shaft, and having a first rotating component and a second rotating component which are engagable with and disengageable from each other, the first rotating component of the first clutch being connected to the first input shaft, and the second rotating component of the first clutch being connected to the second input shaft, for enabling driving connection between the first input shaft and the second input shaft; a differential, having a differential housing provided with an input gear, the input gear being drivingly connected to the second rotating component of the first clutch; two output shafts, one end of each of the two output shafts being drivingly connected to the differential, for enabling transmission of power from the differential; and a second clutch, disposed on any one of the two output shafts, for enabling interruption of the transmission of the power from the differential.

The drive mechanism for an electric vehicle according to the present disclosure has a compact structure, improves the space utilization in the vehicle, and can rapidly interrupt the transmission of power from a driving device to wheels.

The second clutch is a dog clutch.

The second rotating component of the first clutch includes a body portion and a rotating shaft connected to the body portion, the body portion being directly engageable with the first rotating component of the first clutch, an intermediate gear is non-rotatably arranged on the rotating shaft, and the intermediate gear is drivingly connected to the input gear of the differential. Specifically, the intermediate gear is meshed directly with the input gear of the differential.

The drive mechanism for an electric vehicle further includes a planetary gear mechanism, the planetary gear mechanism including a sun gear, a planetary gear, a ring gear, and a planetary carrier for supporting the planetary gear, where the sun gear is drivingly connected to the second input shaft, and the planetary carrier is drivingly connected to the rotating shaft of the second rotating component of the first clutch.

The drive mechanism for an electric vehicle further includes: a damper, disposed between the first input shaft and the first clutch, an input end of the damper being drivingly connected to the first input shaft, and an output end of the damper being drivingly connected to the first rotating component of the first clutch.

The damper is a torsional damper.

The intermediate gear is a first intermediate gear, and the drive mechanism for an electric vehicle further includes a second intermediate gear meshed with the first intermediate gear.

The second intermediate gear is disposed between the first intermediate gear and the input gear of the differential, and drivingly connects the first intermediate gear to the input gear of the differential.

The drive mechanism for an electric vehicle further includes a third intermediate gear, where the third intermediate gear is coaxial with and rotates together with the second intermediate gear, and the third intermediate gear is meshed with the input gear of the differential.

The present disclosure provides a range extension device for an electric vehicle, the range extension device including: a motor-generator; and a drive mechanism for an electric vehicle mentioned above, where the second input shaft of the drive mechanism for an electric vehicle is drivingly connected to the motor-generator.

The motor-generator is a permanent magnet synchronous motor.

The present disclosure provides a range extension system for an electric vehicle, the range extension system including: an internal combustion engine; and a range extension device for an electric vehicle mentioned above, where the first input shaft of the drive mechanism for an electric vehicle is drivingly connected to a crankshaft of the internal combustion engine.

The internal combustion engine is an in-line four-cylinder internal combustion engine.

The present disclosure provides an electric vehicle, including: a range extension system for an electric vehicle; and a pair of wheels, which is a pair of front wheels or a pair of rear wheels of the electric vehicle, where the other end of each of the two output shafts of the drive mechanism for an electric vehicle is drivingly connected to a corresponding wheel of the pair of wheels.

The electric vehicle includes a main driving system, the main driving system including a main driving motor and a main speed reducer drivingly connected to the main driving motor, where the main driving system is configured to drive a pair of wheels different from the pair of wheels driven by the range extension system for an electric vehicle.

The main driving system is configured to drive a pair of rear wheels of the electric vehicle when the range extension device for an electric vehicle is configured to drive a pair of front wheels of the electric vehicle. Typically, the main driving system is always in an operating state when the vehicle is running, and the range extension device for an electric vehicle operates as required according to the conditions of the vehicle itself and road conditions, to achieve driving, power generation, or both driving and power generation.

The present disclosure further provides a method for controlling a range extension device for an electric vehicle, the method including: step S21: determining a magnitude relationship between an SOC of a traction battery of the electric vehicle and an SOC threshold, or determining both a magnitude relationship between the SOC of the traction battery of the electric vehicle and the SOC threshold and a magnitude relationship between a vehicle speed of the electric vehicle and a vehicle speed threshold; and step S22: selecting an operating mode of the range extension device according to a determination result.

Preferably, when it is determined in step S21 that the SOC of the traction battery is greater than a first SOC threshold, step S22 includes: controlling the internal combustion engine to not operate, the first clutch to be disengaged, and the second clutch to be engaged, such that the motor-generator drives the pair of wheels via the differential and the second clutch, for enabling a purely electric mode of the range extension device for an electric vehicle.

Preferably, when it is determined in step S21 that the SOC of the traction battery is less than the first SOC threshold but greater than a second SOC threshold, and the vehicle speed is greater than a first vehicle speed threshold, step S22 includes: controlling both the first clutch and the second clutch to be engaged such that the internal combustion engine and the motor-generator jointly drive the pair of wheels via the differential and the second clutch, for enabling a hybrid driving mode of the range extension device for an electric vehicle.

Preferably, when it is determined in step S21 that the SOC of the traction battery is less than the second SOC threshold but greater than a third SOC threshold, and the vehicle speed is greater than the vehicle speed threshold, step S22 includes: controlling both the first clutch and the second clutch to be engaged such that a part of power of the internal combustion engine is transmitted to the motor-generator for generating electricity, and the other part of the power of the internal combustion engine drives the pair of wheels via the first clutch, the differential and the second clutch, for enabling a first range extension mode of the range extension device for an electric vehicle.

Preferably, when it is determined in step S21 that the SOC of the traction battery is less than the third SOC threshold, and the vehicle speed is less than the vehicle speed threshold, step S22 includes: controlling the first clutch to be engaged and the second clutch to be disengaged such that power of the internal combustion engine is only transmitted to the motor-generator for generating electricity, for enabling a second range extension mode of the range extension device for an electric vehicle.

Preferably, the method further includes: step S23: controlling the first clutch to be engaged and the second clutch to be disengaged when starting the vehicle, and using power from the motor-generator to start the internal combustion engine.

The present disclosure further provides a program product, including a program including a plurality of instructions, where the instructions execute the method for controlling a range extension device for an electric vehicle when the program is run on a vehicle-mounted computer. The program product is, for example, a program carrier, such as a hard drive.

The speed reducer, the range extension device and/or the range extension system for an electric vehicle according to the present disclosure have a compact structure and improve the space utilization in the vehicle. By using the method of controlling a range extension device for an electric vehicle according to the present disclosure, multiple operating modes can be automatically switched according to the SOC of the traction battery and the vehicle speed.

### BRIEF DESCRIPTION OF THE DRAWINGS

Features, advantages and technical and industrial significance of exemplary embodiments of the present disclosure will be described below with reference to the accompanying drawings, where the same reference numerals represent the same elements. Obviously, the accompanying drawings described below show merely some of the embodiments of the present disclosure, and those of ordinary skill in the art would also be able to change these accompanying drawings without any creative effort.

FIG. 1 is a structural schematic diagram of a drive mechanism, a range extension device and a range extension system for an electric vehicle according to a first embodiment.

FIG. 2 is a diagram showing an operating mode of the drive mechanism, the range extension device and the range extension system for an electric vehicle according to the first embodiment.

FIG. 3 is a diagram showing another operating mode of the drive mechanism, the range extension device and the range extension system for an electric vehicle according to the first embodiment.

FIG. 4 is a diagram showing still another operating mode of the drive mechanism, the range extension device and the range extension system for an electric vehicle according to the first embodiment.

FIG. 5 is a diagram showing yet another operating mode of the drive mechanism, the range extension device and the range extension system for an electric vehicle according to the first embodiment.

FIG. 6 is a structural schematic diagram of a drive mechanism, a range extension device and a range extension system for an electric vehicle according to a second embodiment.

FIG. 7 is a diagram showing an operating mode of the drive mechanism, the range extension device and the range extension system for an electric vehicle according to the second embodiment.

FIG. 8 is a diagram showing another operating mode of the drive mechanism, the range extension device and the range extension system for an electric vehicle according to the second embodiment.

FIG. 9 is a diagram showing still another operating mode of the drive mechanism, the range extension device and the range extension system for an electric vehicle according to the second embodiment.

FIG. 10 is a diagram showing yet another operating mode of the drive mechanism, the range extension device and the range extension system for an electric vehicle according to the second embodiment.

FIG. 11 is a structural schematic diagram of a drive mechanism, a range extension device and a range extension system for an electric vehicle according to a third embodiment.

FIG. 12 is a structural schematic diagram of a power coupling device of an electric vehicle in the prior art.

FIG. 13 is a comparison chart of SOC and vehicle speed and respective thresholds according to various embodiments.

### DETAILED DESCRIPTION OF EMBODIMENTS

Various embodiments of the present disclosure will be described below with reference to the accompanying drawings to illustrate specific embodiments in which the present disclosure may be implemented. The expressions such as “left” and “right” appear in the specification are merely intended to describe the present disclosure with reference to the accompanying drawings, rather than limiting the present disclosure, and it should be understood that the expression such as “left” or “right” indicates only one direction and may be exchanged.

### First Embodiment

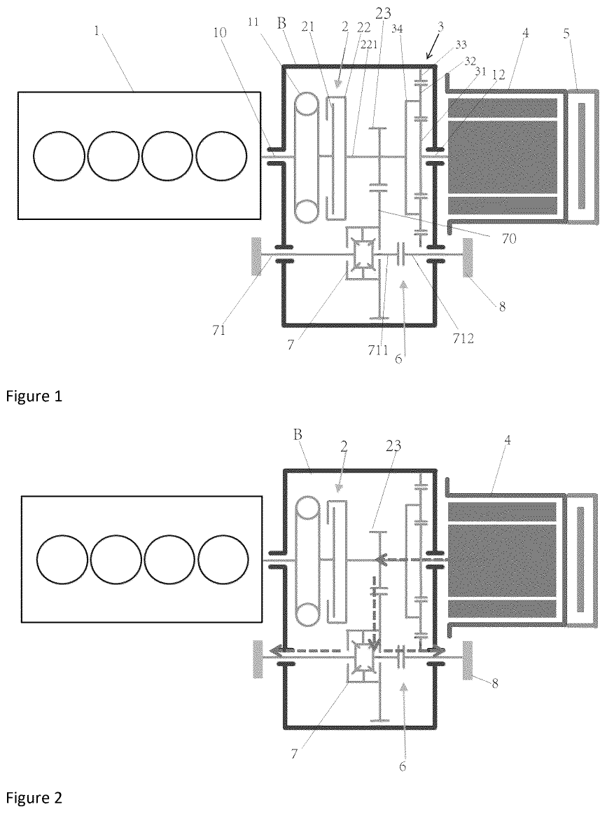

FIG. 1 is a structural schematic diagram of a drive mechanism, a range extension device and a range extension system for an electric vehicle according to the first embodiment. As shown in FIG. 1, the range extension system for an electric vehicle according to the first embodiment includes: an internal combustion engine 1; a motor-generator 4; and a drive mechanism located between the internal combustion engine 1 and the motor-generator 4. The drive mechanism can couple and output power from the internal combustion engine 1 and the motor-generator 4. The internal combustion engine 1 and the motor-generator 4 are preferably located on two opposite sides of the drive mechanism.

The drive mechanism includes two input shafts, that is, a first input shaft 10 and a second input shaft 12. Both the first input shaft 10 and the second input shaft 12 are rotatably supported. The first input shaft 10 and the second input shaft 12 are used for receiving power input from corresponding power sources.

The drive mechanism further includes a first clutch 2 disposed between the first input shaft 10 and the second input shaft 12. The first clutch 2 includes a first rotating component 21 and a second rotating component 22 that can be engaged with and disengaged from each other. The first rotating component 21 is connected to the first input shaft 10 and thus connected to the internal combustion engine 1, specifically, to a crankshaft of the internal combustion engine. The second rotating component 22 is connected to the second input shaft 12 and thus connected to the motor-generator 4, specifically, to an output shaft of the motor-generator. In this way, the first clutch 2 can drivingly connect the first input shaft 10 to the second input shaft 12. Accordingly, the first clutch 2 can drivingly connect the internal combustion engine 1 to the motor-generator 4.

The drive mechanism for an electric vehicle further includes a differential 7 provided with an input gear 70. The input gear 70 of the differential is drivingly connected to the second rotating component 22 of the first clutch 2 and thus can receive power from the second rotating component 22.

The drive mechanism for an electric vehicle further includes two output shafts 71. One end of each of the two output shafts 71 is drivingly connected to the differential 7 and thus can transmit the power from the differential 7. The output shaft 71 is configured to transmit power to a pair of wheels of the electric vehicle. Specifically, each output shaft 71 may be connected to a corresponding one of the pair of wheels 8 of the electric vehicle for transmitting the power from the differential 7 to the pair of wheels 8. The pair of wheels 8 is a pair of front wheels or a pair of rear wheels of the electric vehicle.

The drive mechanism for an electric vehicle further includes a second clutch 6 disposed between the differential 7 and one wheel of the pair of wheels 8. Preferably, the second clutch 6 may be disposed on any one of the output shafts 71, and thus can interrupt the transmission of the power from the differential 7 and then interrupt the transmission of the power between the differential 7 and the pair of wheels 8 of the electric vehicle.

The type of the second clutch 6 is also not limited. However, preferably, the second clutch 6 is a dog clutch (also known as a jaw clutch or claw clutch). The dog clutch may be a radial dog clutch or an axial dog clutch. In the case of the radial dog clutch, the output shaft 71 provided with the dog clutch includes a first shaft portion 711 connected to the differential 7 and a second shaft portion 712 connected to one of the wheels 8. The dog clutch includes a first external spline disposed on the first shaft portion, a second external spline disposed on the second shaft portion, and a sliding sleeve provided with an internal spline. The sliding sleeve is slidably disposed on one of the first external spline and the second external spline by the internal spline thereof and is axially actuated to engage the internal spline thereof with the other external spline when engagement is required, and thus synchronous rotation of the first shaft portion and the second shaft portion is achieved. The dog clutch has the structural characteristics of a simple structure, a small drag loss and a small outline dimension, and the two connected shafts do not rotate relatively after the engagement. The dog clutch is convenient to operate, can transmit a large torque, and can effectively prevent overload and overheating and prolong the service life of an apparatus. The dog clutch further has a characteristic of fast response. By using the dog clutch, the drive mechanism for an electric vehicle according to the present disclosure has a smaller size and can achieve rapid driving (primary driving or secondary driving) of the electric vehicle.

The first clutch 2 may be any type of clutch, for example, a friction clutch. The friction clutch has the advantages of simple structure and low costs. As described above, the second rotating component 22 of the first clutch 2 is drivingly connected to the second input shaft 12 and/or the motor-generator 4. It should be readily understood that the second rotating component 22 of the first clutch 2 may be directly drivingly connected to the output shaft of the motor-generator 4, and in this case, the second rotating component 22 includes the second input shaft 12. Alternatively, the second rotating component 22 of the first clutch 2 may be drivingly connected to the output shaft of the motor-generator 4 via a speed reduction device.

The differential 7 is a conventional type of differential. Each output shaft 71 of the drive mechanism has one end drivingly connected to the corresponding wheel 8 of the electric vehicle, and the other end drivingly connected to the differential 7. In this case, the output shaft 71 of the drive mechanism may also be regarded as the output shaft of the differential 7 itself. The specific structure of the differential may be known and will not be described in detail herein.

The driving connection between the input gear 70 of the differential 7 and the first clutch 2 may be achieved in a variety of ways. For example, an outer peripheral edge of the second rotating component 22 of the first clutch 2 may have teeth that are meshed directly with the input gear 70. Alternatively or preferably, the second rotating component 22 of the first clutch 2 includes a body portion and a rotating shaft 221 connected to the body portion. The body portion can be directly engaged with the first rotating component 21 of the first clutch 2, and an intermediate gear 23 is non-rotatably arranged on the rotating shaft 221. The intermediate gear 23 is meshed with the input gear 70 of the differential 7, and accordingly the power from the first clutch 2 can be transmitted to the differential 7.

As described above, the speed reduction device may be disposed between the first clutch 2 and the motor-generator 4, and the speed reduction device may be, for example, a planetary gear mechanism 3. That is, the drive mechanism includes the speed reduction device such as the planetary gear mechanism 3. The planetary gear mechanism 3 includes a sun gear 31, a planetary gear 32, a ring gear 33, and a planetary carrier 34 for supporting the planetary gear. The sun gear 31 is drivingly connected to the second input shaft 12 and thus drivingly connected to the output shaft of the motor-generator 4, and the planetary carrier 34 is drivingly connected to the second rotating component 22 of the first clutch 2, specially, to the rotating shaft 221. In this way, the planetary gear mechanism 3 can transmit the power between the first clutch 2 and the motor-generator 4 and decelerate the rotation of the motor-generator 4.

The first rotating component 21 of the first clutch 2 may be directly drivingly connected to a power source, for example, the internal combustion engine 1. Preferably, for buffering and damping an output of an external power source such as the internal combustion engine 1, the drive mechanism for an electric vehicle may be provided with a damper 11 disposed between the first input shaft 10 and the first clutch 2. An input end of the damper 11 is drivingly connected to the first input shaft 10 and thus can be connected to the crankshaft of the internal combustion engine 1, and an output end of the damper 11 is drivingly connected to the first rotating component 21 of the first clutch 2. The damper is preferably a torsional damper. However, the damper may be other types of dampers, for example, a hydraulic damper.

Preferably, the drive mechanism may include a housing B, and the internal combustion engine 1 and the motor-generator 4 are located on two opposite sides of the housing B. The housing B may be fixed, for example, to a frame of the electric vehicle. When the drive mechanism is provided with the housing B, the first input shaft 10 is rotatably supported in a wall on one side of the housing B, and the second input shaft 12 is rotatably supported in a wall on a second side, opposite to the one side, of the housing B. For example, the engine 1 is located on the one side, and the motor-generator 4 is located on the other side. The damper 11 and the planetary gear mechanism 3 may be disposed inside or outside the housing B. The first clutch 2 is preferably disposed inside the housing B. The differential 7 is preferably disposed inside the housing B. One of the two output shafts 71 is rotatably supported in the wall on one side of the housing B, and the other output shaft is rotatably supported in the wall on the other side of the housing B. It should be understood that positional relationships of all components of the drive mechanism relative to the housing B are not restrictive, but may be appropriately selected according to actual requirements. The configuration of the housing B is not limited, for example, the housing B may not have any wall in an axial direction of the input shaft or the output shaft.

All the components of the drive mechanism for an electric vehicle that has the above structure are reasonable in layout and compact in structure, thereby facilitating assembly and space saving, and improving the space utilization in the vehicle.

The range extension device for an electric vehicle of the present disclosure includes the drive mechanism described above and a motor-generator 4. The second input shaft 12 of the drive mechanism for an electric vehicle is drivingly connected to the motor-generator 4.

The motor-generator 4 is a motor that may be used as both an electric motor and a generator. The motor-generator 4 is provided with an inverter 5 for controlling the operation of the motor-generator 4. The motor-generator is preferably a permanent magnet synchronous motor (PSM). However, it should be understood that the type of the motor-generator 4 is not limited.

The range extension system for an electric vehicle of the present disclosure includes the range extension device described above and an internal combustion engine 1. The first input shaft 10 of the drive mechanism for an electric vehicle is drivingly connected to a crankshaft of the internal combustion engine 1. The specific type of the internal combustion engine 1 is not limited, for example, the engine may be an in-line four-cylinder internal combustion engine, a horizontally opposed six-cylinder internal combustion engine, and a V-type twelve-cylinder internal combustion engine. Output parameters of the internal combustion engine, such as a maximum output power, are also not limited, but are selected according to requirements. In this way, the internal combustion engine 1 and the motor-generator 4 may jointly provide power to the electric vehicle.

A range extension device and/or a range extension system in the prior art typically use two motors, one of which is dedicated to generating electricity, and the other is dedicated to driving for achieving a range extension function. This makes the device bulky and increases the cost. However, the above range extension device and/or range extension system of the present disclosure can achieve both power generation and vehicle driving functions using only one motor, namely, the motor-generator 4, and accordingly achieves the range extension function with low cost and low space occupation.

The electric vehicle of the present disclosure includes the range extension system described above and a pair of wheels 8, which is a pair of front wheels or a pair of rear wheels of the electric vehicle. The other end of each of the two output shafts of the drive mechanism for an electric vehicle is drivingly connected to a corresponding wheel of the pair of wheels 8. The range extension system according to the present disclosure may be the only driving system of the electric vehicle. In this way, efficient power generation and driving of the electric vehicles can be achieved without any additional driving system. As a result, the cost is reduced.

It should be readily understood that the range extension system according to the present disclosure can be used as an auxiliary driving system of the electric vehicle. In this way, additionally, the electric vehicle of the present disclosure may include a main driving system. The main driving system includes a main driving motor and a main speed reducer drivingly connected to the main driving motor. The main driving system is configured to drive a pair of wheels different from the pair of wheels 8 driven by the range extension system for an electric vehicle. For example, the main driving system may be configured to drive the pair of rear wheels of the electric vehicle, and the range extension system according to the present disclosure may be configured to drive the pair of front wheels of the electric vehicle. Since the main driving system itself can achieve two-wheel drive of the electric vehicle, the electric vehicle of the present disclosure can easily achieve four-wheel drive of the electric vehicle.

By using the range extension device and/or range extension system for an electric vehicle that have the above structure, the damper can be easily mounted to the internal combustion engine, high power density and good smoothness are achieved, and the entire range extension device and/or range extension system is highly integrated and compact, thereby achieving low drag loss during glide of the electric vehicle.

The range extension system for an electric vehicle according to the first embodiment has multiple operating modes, including a purely electric mode, a hybrid driving mode, a first range extension mode and a second range extension mode, and can automatically switch the multiple modes according to the requirements for an SOC of a traction battery and a vehicle speed. Thus, the present disclosure further provides a method for controlling a range extension system for an electric vehicle. The method includes: step S21 of determining a magnitude relationship between an SOC of a traction battery of the electric vehicle and an SOC threshold, or determining both a magnitude relationship between the SOC of the traction battery of the electric vehicle and the SOC threshold and a magnitude relationship between a vehicle speed of the electric vehicle and a vehicle speed threshold; and step S22 of selecting an operating mode of the range extension system according to a determination result.

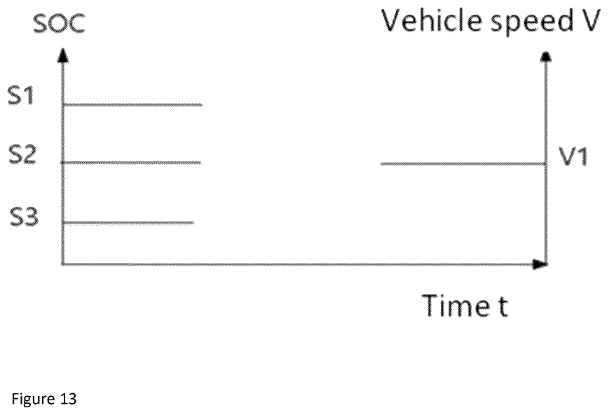

As shown in FIG. 13, the SOC threshold includes three thresholds, namely, a first SOC threshold S1, a second SOC threshold S2 less than the first SOC threshold S1, and a third SOC threshold 3 less than the second SOC threshold S2. The operating mode of the range extension system is selected on the basis of the relationship between the SOC of the traction battery of the electric vehicle and the corresponding SOC threshold and the relationship between the vehicle speed V and a vehicle speed threshold V1.

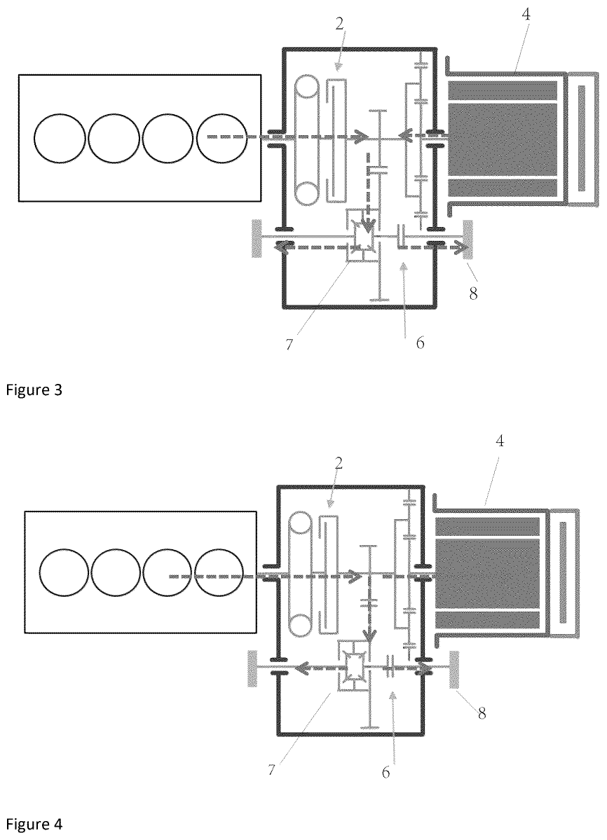

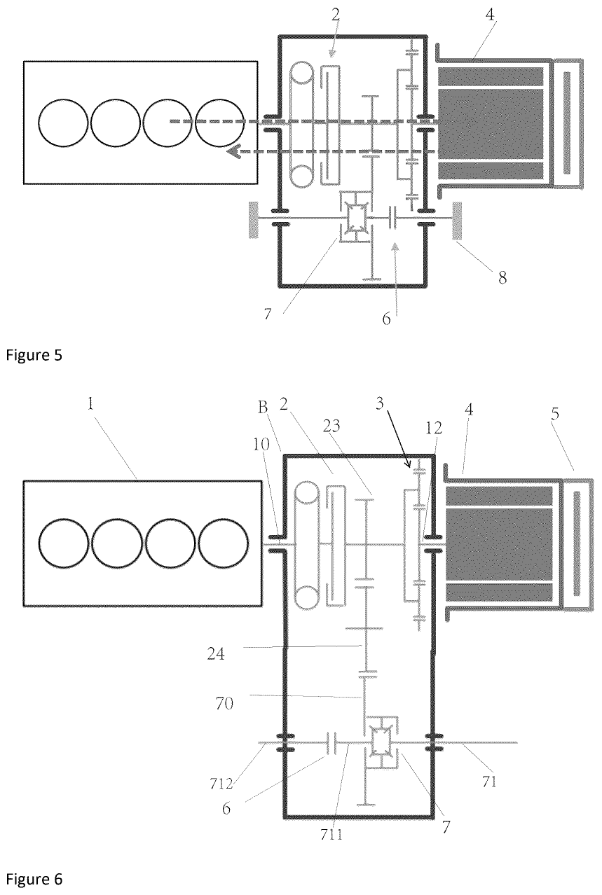

FIG. 2 is a diagram showing an operating mode of the range extension system for an electric vehicle according to the first embodiment. FIG. 3 is a diagram showing another operating mode of the range extension system for an electric vehicle according to the first embodiment. FIG. 4 is a diagram showing still another operating mode of the range extension system for an electric vehicle according to the first embodiment. FIG. 5 is a diagram showing yet another operating mode of the range extension system for an electric vehicle according to the first embodiment.

Specifically, as shown in FIG. 2, when it is determined in step S21 that the SOC of the traction battery of the electric vehicle is greater than the first SOC threshold S1, step S22 includes: controlling the internal combustion engine 1 to not operate, the motor-generator 4 to operate as the driving motor, the first clutch 2 to be disengaged, and the second clutch 6 to be engaged, to transmit power from the motor-generator 4 to the differential 7 via the second rotating component 22 of the first clutch 2 (or the intermediate gear 23 rotating together with the second rotating component 22), and then transmit the power to a pair of wheels 8 to drive the electric vehicle. In this case, the range extension system for an electric vehicle operates in the purely electric mode, and a power transmission path is as shown by the dashed arrows in FIG. 2. In this case, the main driving system (not shown) of the electric vehicle is typically configured to drive the other pair of wheels different from the pair of wheels 8 of the electric vehicle. Therefore, when the range extension system for an electric vehicle operates in the purely electric mode, the four-wheel drive of the electric vehicle is achieved.

As shown in FIG. 3, when it is determined in step S21 that the SOC of the traction battery is less than the first SOC threshold S1 but greater than the second SOC threshold S2, and the vehicle speed V is greater than the vehicle speed threshold V1, step S22 includes: controlling the internal combustion engine 1 to operate, the motor-generator 4 to operate as the driving motor, and both the first clutch 2 and the second clutch 6 to be engaged, to couple the power of the internal combustion engine 1 and the power of the motor-generator 4 via the second rotating component 22 of the first clutch 2, and then to transmit the power to the differential 7 and then to the pair of wheels 8. In this case, the range extension system for an electric vehicle operates in a hybrid power mode, and the power transmission path is as shown by the dashed arrows in FIG. 3. In this case, the main driving system of the electric vehicle is typically configured to drive the other pair of wheels different from the pair of wheels 8 of the electric vehicle. Therefore, when the range extension system for an electric vehicle operates in the hybrid power mode, the four-wheel drive of the electric vehicle is achieved.

As shown in FIG. 4, when it is determined in step S21 that the SOC of the traction battery is less than the second SOC threshold S2 but greater than the third SOC threshold S3, and the vehicle speed V is greater than the vehicle speed threshold V1, step S22 includes: controlling the internal combustion engine 1 to operate, the motor-generator 4 to operate as the generator, and both the first clutch 2 and the second clutch 6 to be engaged, to transmit a part of the power of the internal combustion engine 1 to the motor-generator 4 via the first clutch 2 to generate electricity, and to transmit the other part of the power of the internal combustion engine 1 to the pair of wheels 8 via the first clutch 2, the differential 7 and the second clutch 6. The electricity generated by the motor-generator 4 is stored in the traction battery (not shown) of the electric vehicle. In this case, the range extension system for an electric vehicle operates in the first range extension mode, and the power transmission path is as shown by the dashed arrows in FIG. 4. In this case, the main driving system of the electric vehicle is typically configured to drive the other pair of wheels different from the pair of wheels 8 of the electric vehicle. Therefore, when the range extension system for an electric vehicle operates in the first range extension mode, the four-wheel drive of the electric vehicle is also achieved.

As shown in FIG. 5, when it is determined in step S21 that the SOC of the traction battery is less than the third SOC threshold S3, and the vehicle speed is less than the vehicle speed threshold V1, step S22 includes: controlling the first clutch 2 to be engaged, and the second clutch 6 to be disengaged, and the internal combustion engine 1 driving the motor-generator 4 via the first clutch 2 to generate electricity, so as to charge the traction battery. In this case, the range extension system for an electric vehicle operates in the second range extension mode, in which only electricity is generated. The electricity generated by the motor-generator 4 is stored in the traction battery (not shown) of the electric vehicle. In this case, if the main driving system of the electric vehicle is driving the other pair of wheels different from the pair of wheels 8 of the electric vehicle, the electric vehicle is driven in a two-wheel drive mode in a low-speed region when the range extension system for an electric vehicle operates in the second range extension mode. The power transmission path is as shown by the dashed arrow on the upper side in FIG. 5.

Further, as shown in FIG. 5, when the electric vehicle is started, the motor-generator 4 may be used as the driving motor to start the internal combustion engine 1. The power transmission path is as shown by the dashed arrow on the lower side in FIG. 5. Accordingly, the method for controlling a range extension system for an electric vehicle in this embodiment further includes: step S23 of controlling the motor-generator 4 to generate a starting torque during startup to start the internal combustion engine 1.

In the first range extension mode and the second range extension mode mentioned above, because of the lower SOC of the traction battery, the internal combustion engine 1 drives the motor-generator 4 to charge the traction battery in order to quickly increase the SOC of the traction battery.

The above operating modes are illustrated in Table 1 as follows:

TABLE 1

| Operating | SOC of | Vehicle speed | | | | Vehicle |
|---|---|---|---|---|---|---|
| mode | traction battery | v | First clutch | Second clutch | Mode description | drive mode |
| 1 | greater than | Full vehicle | Disengaged | Engaged | Purely electric mode: | Four-drive |
| | the first SOC | speed | | | Driven by only the | mode |
| | threshold S1 | | | | motor | |
| 2 | Greater than | Greater than | Engaged | Engaged | Hybrid mode: | Four-drive |
| | the second | the vehicle | | | The internal | mode |
| | SOC threshold | speed | | | combustion engine | |
| | S2 | threshold V1 | | | and the motor jointly | |
| | | | | | drive the vehicle | |
| 3 | Greater than | Greater than | Engaged | Engaged | First range extension | Four-drive |
| | the third SOC | the vehicle | | | mode: The internal | mode |
| | threshold S3 | speed | | | combustion engine | |
| | | threshold V1 | | | drives the vehicle | |
| | | | | | and simultaneously | |
| | | | | | drives the motor to | |
| | | | | | generate electricity | |
| 4 | Less than the | Less than the | Engaged | Disengaged | Second range | Two-drive |
| | third SOC | vehicle speed | | | extension mode: | mode |
| | threshold S3 | threshold V1 | | | The internal | |
| | | | | | combustion engine | |
| | | | | | does not drive the | |
| | | | | | vehicle, and only | |
| | | | | | drives the motor to | |
| | | | | | generate electricity | |
| 5 | | 0 | Engaged | Disengaged | The motor reversely | Start the |
| | | | | | starts the internal | vehicle |
| | | | | | combustion engine | |

Each of the above SOC thresholds is used for determining whether the SOC of the traction battery is high or low, and the vehicle speed threshold is used for determining whether the vehicle speed is high or low. In this embodiment, the specific values of the SOC thresholds and the vehicle speed threshold are not limited. Generally, the thresholds can be freely set according to a specific control strategy, and the value of any one of the SOC thresholds and the vehicle speed threshold is different depending on control strategies. After the SOC thresholds and the vehicle speed threshold are set, the electric vehicle automatically makes determinations and automatically switches the modes according to determination results.

Furthermore, when the vehicle is braked, the first clutch 2 is disengaged and the second clutch 6 is engaged to generate a braking torque for braking the wheels by using the motor-generator 4, and an induced current is thus generated in a winding of the motor-generator 4 to charge the traction battery, thereby recovering braking energy. Thus, the control method of this embodiment further includes: controlling the second clutch 6 to generate the braking torque during braking, and generating the induced current in the winding of the motor-generator 4 to charge the traction battery of the electric vehicle.

Moreover, according to the range extension system for an electric vehicle that has the above configuration, both the internal combustion engine and the motor-generator can be disconnected from the wheels 8 of the electric vehicle by simply disengaging the second clutch 6, and accordingly the transmission of driving power is interrupted.

### Second Embodiment

FIG. 6 is a structural schematic diagram of a drive mechanism, a range extension device and a range extension system for an electric vehicle according to a second embodiment. The description of the parts of the second embodiment that are the same as those of the first embodiment will be omitted herein, and only different parts will be described.

Different from the first embodiment, as shown in FIG. 6, in the second embodiment, the intermediate gear 23 is a first intermediate gear, and the drive mechanism for an electric vehicle further includes a second intermediate gear 24. The second intermediate gear 24 is meshed with the first intermediate gear.

Specifically, the second intermediate gear 24 is disposed between the first intermediate gear and the input gear 70 of the differential 7, and drivingly connects the first intermediate gear to the input gear 70 of the differential 7. In addition, different from the shown in FIG. 1, as shown in FIG. 6, the second clutch 6 is disposed on the left output shaft 71 of the drive mechanism. It should be understood that the second clutch 6 is disposed on any one of the left and right output shafts of the drive mechanism, and can interrupt the power transmission between the differential 7 and the pair of wheels 8 in both cases, with the same effect.

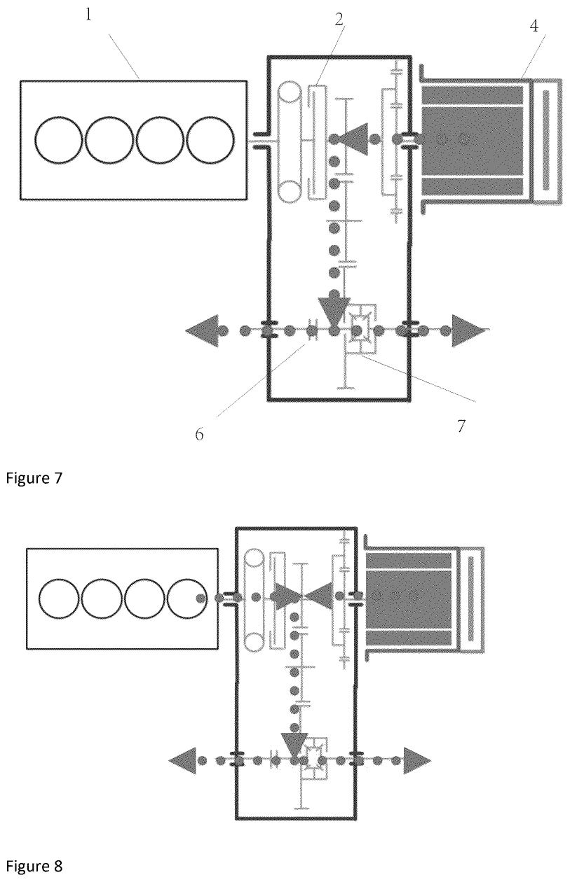

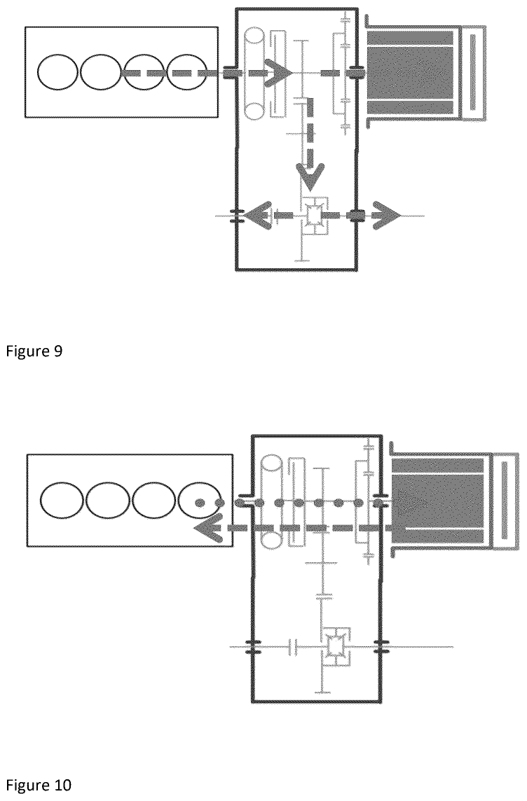

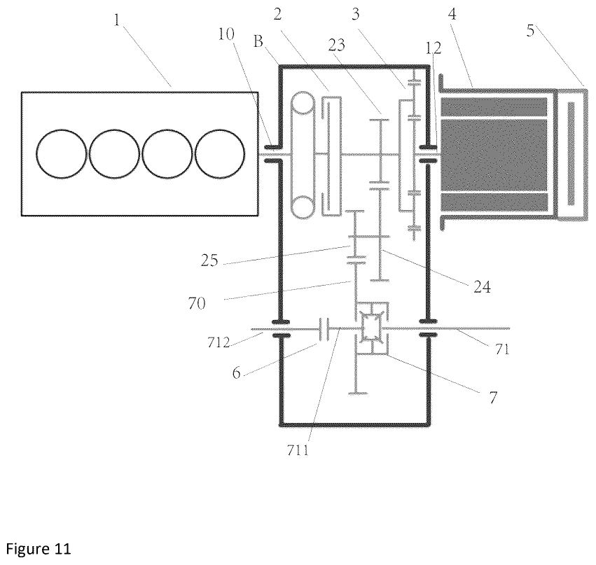

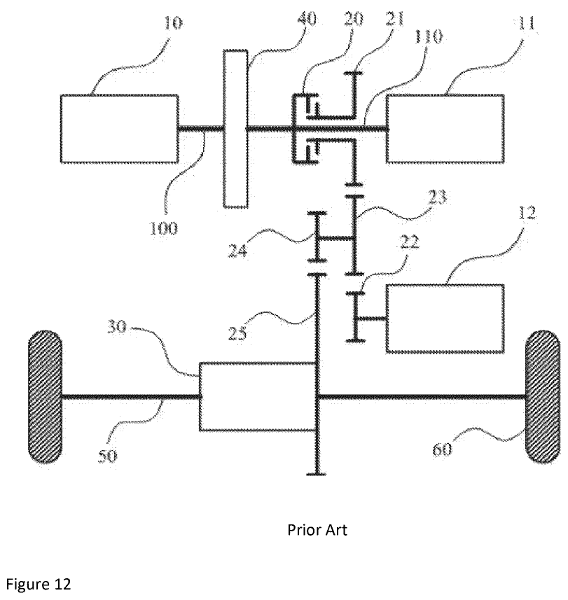

FIG. 7 is a diagram showing an operating mode of the range extension system for an electric vehicle according to the second embodiment. FIG. 8 is a diagram showing another operating mode of the range extension system for an electric vehicle according to the second embodiment. FIG. 9 is a diagram showing still another operating mode of the range extension system for an electric vehicle according to the second embodiment. FIG. 10 is a diagram showing yet another operating mode of the range extension system for an electric vehicle according to the second embodiment. The operating modes shown in FIGS. 7-10 include operating states of the components and directions of a power flow, which are corresponding to the respective operating modes shown in FIGS. 2-5 of the first embodiment. Therefore, the operating modes shown in FIG. 7-10 will not be described in detail.

It should be noted that in the first embodiment, the first intermediate gear 23 is directly drivingly connected to the input gear 70 of the differential 7. Compared to the first embodiment, in the drive mechanism for an electric vehicle according to the second embodiment, primary speed reduction is achieved from the first intermediate gear 23 to the second intermediate gear 24. However, it should be readily understood that a multi-stage speed reduction may be achieved between the first intermediate gear 23 and the input gear 70 of the differential 7.

### Third Embodiment

FIG. 11 is a structural schematic diagram of a drive mechanism, a range extension device and a range extension system for an electric vehicle according to a third embodiment. The description of the parts of the third embodiment that are the same as those of the first and second embodiments will be omitted herein, and only different parts will be described.

Different from the second embodiment, as shown in FIG. 11, in the third embodiment, the drive mechanism for an electric vehicle further includes a third intermediate gear 25. The third intermediate gear 25 is coaxial with and rotates together with the second intermediate gear 24, and the third intermediate gear 25 is meshed with the input gear 70 of the differential 7. The third intermediate gear 25 and the second intermediate gear 24 have different numbers of teeth.

Compared to the first and second embodiments, in the drive mechanism for an electric vehicle according to the third embodiment, two-stage speed reduction can be achieved between the first intermediate gear 23 and the input gear 70 of the differential 7.

The range extension system for an electric vehicle of the third embodiment shown in FIG. 11 has operating modes corresponding to the respective operating modes as shown in FIGS. 2-5 of the first embodiment. Therefore, the operating modes of the range extension system for an electric vehicle of the third embodiment shown in FIG. 11 will not be described in detail.

Furthermore, the present disclosure further provides a program product, for example, a program carrier or a computer medium. The program product includes a program including a plurality of instructions, where the instructions execute the method for controlling a range extension system for an electric vehicle when the program is run on a vehicle-mounted computer.

The preferred embodiments of the present disclosure are described above, but these embodiments are not intended to limit the scope of the claims of the present disclosure. Therefore, while not departing from the scope of protection defined in the claims of the present disclosure, various embodiments may be modified without departing from the spirit of the present disclosure and equivalents thereof.

1. A drive mechanism for an electric vehicle, the drive mechanism comprising:
a first input shaft;
a second input shaft;
a first clutch disposed between the first input shaft and the second input shaft, and having a first rotating component and a second rotating component which are engagable with and disengageable from each other, the first rotating component of the first clutch being connected to the first input shaft, and the second rotating component of the first clutch being connected to the second input shaft, for enabling a driving connection between the first input shaft and the second input shaft;
a differential having a differential housing provided with an input gear, the input gear being drivingly connected to the second rotating component of the first clutch;
two output shafts, one end of each of the two output shafts being drivingly connected to the differential and configured to enable transmission of power from the differential; and
a second clutch disposed on at least one of the two output shafts and configured to enable interruption of the transmission of the power from the differential.

2. The drive mechanism according to claim 1,
wherein the second clutch is a dog clutch.

3. The drive mechanism according to claim 1,
wherein the second rotating component of the first clutch comprises a body portion and a rotating shaft connected to the body portion, the body portion configured to be directly engaged with the first rotating component of the first clutch,
wherein an intermediate gear is non-rotatably arranged on the rotating shaft, and
wherein the intermediate gear is drivingly connected to the input gear of the differential.

4. The drive mechanism according to claim 3, comprising:
a planetary gear mechanism comprising a sun gear, a planetary gear, a ring gear, and a planetary carrier configured to support the planetary gear,
wherein the sun gear is drivingly connected to the second input shaft, and
wherein the planetary carrier is drivingly connected to the rotating shaft of the second rotating component of the first clutch.

5. The drive mechanism according to claim 3,
wherein the intermediate gear is a first intermediate gear, and
wherein the drive mechanism comprises a second intermediate gear meshed with the first intermediate gear.

6. The drive mechanism according to claim 5,
wherein the second intermediate gear is disposed between the first intermediate gear and the input gear of the differential, and drivingly connects the first intermediate gear to the input gear of the differential.

7. The drive mechanism according to claim 5, comprising:
a third intermediate gear, wherein the third intermediate gear is coaxial with and rotates together with the second intermediate gear,
wherein the third intermediate gear is meshed with the input gear of the differential.

8. The drive mechanism according to claim 1, comprising:
a damper disposed between the first input shaft and the first clutch, an input end of the damper being drivingly connected to the first input shaft, and an output end of the damper being drivingly connected to the first rotating component of the first clutch.

9. The drive mechanism according to claim 8,
wherein the damper is a torsional damper.

10. A range extension device for the electric vehicle, the range extension device comprising:
a motor-generator; and
the drive mechanism according to claim 1,
wherein the second input shaft of the drive mechanism is drivingly connected to the motor-generator.

11. The range extension device according to claim 10,
wherein the motor-generator is a permanent magnet synchronous motor.

12. A range extension system for the electric vehicle comprising:
an internal combustion engine; and
the range extension device according to claim 10,
wherein the first input shaft of the drive mechanism is drivingly connected to a crankshaft of the internal combustion engine.

13. The range extension system according to claim 12,
wherein the internal combustion engine is an in-line four-cylinder internal combustion engine.

14. An electric vehicle, comprising:
the range extension system according to claim 12; and
a first pair of wheels comprising a pair of front wheels or a pair of rear wheels of the electric vehicle,
wherein another end of each of the two output shafts of the drive mechanism is drivingly connected to a corresponding wheel of the first pair of wheels.

15. The electric vehicle according to claim 14, comprising:
a main driving system comprising a main driving motor and a main speed reducer drivingly connected to the main driving motor,
wherein the main driving system is configured to drive a second pair of wheels different from the first pair of wheels driven by the range extension system.
